(19) United States
(12) Patent Application Publication
(10) Pub. No.: US 2009/0018954 A1
(43) Pub. Date: Jan. 15, 2009

(54) A MOBILE WIRELESS FINANCIAL INSTRUMENT

(75) Inventor: John Richard Roberts, Beaverton, OR (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/776,016

(22) Filed: Jul. 11, 2007

(51) Int. Cl. G06Q 40/00

(52) U.S. Cl. 705/39

(57) ABSTRACT

The specification and drawing figures describe and show computer implemented financial data apparatus that includes a mobile wireless communications instrument. A data processing system is operatively connected to the mobile wireless communications instrument. A plurality of user programmable sets, of instruction executable by the data processing system is provided. The combination of the mobile wireless communications instrument and plurality of user programmable sets of instruction executable by the data processing system allows a user to conduct selective financial transactions, such as making payments in connection with a plurality of payment instruments across a credit network, and conducting a variety of other financial transactions across any number of networks and databases.

### BACKGROUND

1. Field

The apparatus, system, and method described, illustrated, and claimed in this document relate generally to a mobile wireless communications instrument capable of allowing a user to conduct financial transactions across one or more communications networks. More specifically, the mobile wireless communications instrument is capable of allowing a consumer to effect payments across a credit network by charging a payment to one or more payment instruments of the user. The mobile wireless communications instrument also is capable of collecting, storing, and transmitting a wide range of customer financial data, personal information, business information, and other information across a wireless communications system.

2. Background

The use of credit cards, debit cards, and similar payment instruments has become the universally preferred means for most consumer purchases of goods and even services. In tandem with the expanded and expanding volume of use of payment instruments to effect point-of-sale payments for purchases has been a concomitant increase in fraudulent transactions affecting payment instruments, including identity theft.

Current constructs for effecting consumer purchases across a financial institution credit network are limited to use of a single payment instrument in connection with purchase. Currently, a consumer must have to the consumer's possession a plastic payment instrument such as a credit card or debit card having a magnetic strip, or being contactless in nature. At the point-of-sale, a credit card reader, or terminal, or similar point-of-sale payment device is provided that requires the consumer to successfully swipe the payment instrument through the point-of-sale device. Over time, from repetitive use, the magnetic strip on the payment instrument degrades, and the data embedded in the magnetic strip may become unreadable for a variety of causes by a point-of-sale device. Degradation of the magnetic strip may cause payment rejection although the consumer may be the authentic owner of the payment instrument. Authentication or verification of the customer is limited to data and information embedded in the magnetic strip of the payment instrument: whoever possesses the payment instrument can effect purchases. The use of personal identification numbers solves the problems neither of customer identification nor customer verification. Customer authentication fails to overcome problems of lost or stolen payment instruments, degraded instruments, or loss of functionality between the payment instrument and point-of-sale payment devices.

There is a worldwide need, therefore, for a secure point-of-sale payment system that allows a consumer, or customer, to selectively direct payments from at least one payment instrument, as well as from more than one payment instrument, without the need to have in the customer's possession a plastic rendition of the payment instrument. There exists also a need for such a system to reduce problems arising from loss of payment instruments, fraud, and rejected payments, but also to allow a customer to make payments from a variety of payment instruments based on logical criteria such as varying interest rates, amounts previously charged to the payment instrument, locale in which the payment is made (for example, a customer may have U.S. payment instruments for transaction in the United States, but a Spanish payment instrument, for example, for frequent trips to Spain).

A worldwide demand also exists for a system that permits a customer to selectively direct payments from one or more payment instruments by use of a portable, or mobile, wireless communication instrument commonly in possession of customers worldwide. At least one example of such a portable, or mobile, wireless communications instrument is a cellular telephone, but any wireless communications instrument to which a computer and/or data processing system may be operatively connected may be used other than a cellular telephone.

In addition, due in pail to increasing mobility of people worldwide, and extensive national and international travel for business and/or pleasure, a need exists for a mobile wireless financial device capable of collecting, storing, receiving, and transmitting a wide range of customer financial data, personal information, and business information that may be revised, updated, and provided across a wireless communications system.

Currently, the well-known credit/debit card-based credit system is anything but paperless. Despite advent of the customer-not-present (“CNP”) electronic telephone authorizations, the vast majority of customers conduct financial transactions across a credit network by using a single credit or debit card, signing a receipt or similar paper confirmation of the transaction, or perhaps conduct the transaction via a touch screen, indicating the amount of payment that may be charged against only a single payment instrument. Paper confirmations of the transactions must be collected and collated. The apparatus, system, and methods disclosed, illustrated, and claimed in this document obviate paper receipts, and offer the prospect of instant payment transactions across a credit network.

### SUMMARY

The apparatus, system, and method disclosed in this document address the above-stated needs by providing a mobile wireless communications instrument. A computer, or data processor, is operatively connected to the mobile wireless communications instrument. In one aspect, the data processing system includes a plurality of user programmable sets of instruction executable by the data processing system for selectively and securely conducting financial transactions using the mobile wireless communications instrument. In another aspect, the data processing system is capable of securely receiving, transmitting, and conducting financial transactions across a credit network. In another aspect, the data processing system is capable of transmitting and receiving programmable payment instructions in connection with not only one payment instrument, but in connection with a plurality of payment instruments, across a credit network. The mobile wireless financial device is also capable of allowing a user of the mobile wireless financial device to receive and transmit a wide variety of financial data across a wireless communications system.

### BRIEF DESCRIPTION OF THE DRAWINGS

FIG. 1 is a schematic block diagram illustrating the point-of-sale device employing a mobile wireless communications instrument;

FIG. 2 is a schematic block diagram illustrating a version of the data processing system of the computer associated with the wireless communications instrument; and

FIG. 3 is a schematic block diagram illustrating the financial data apparatus employing a mobile wireless communications instrument.

### DETAILED DESCRIPTION

### Definitions

The terms “mobile wireless communications instrument” and “portable wireless communications instrument” as used in this document means at least a wireless communication instrument used in a wireless communications system that, in general, includes an array of operatively connected communication devices adapted to receive and transmit at least electromagnetic signals across the system without cables using infrared light and radio signals, and also includes a telecommunications system in which electromagnetic waves, rather than some form of wire, carry the signal over all or part of the communication path. The mobile wireless communications instrument may also receive and transmit signals from satellites, including satellites that are part of the Global Positioning System (GPS), Galileo, GLONASS, NAVSTAR, GNSS, a system that uses satellites from a combination of these systems, or any satellite positioning system subsequently developed (collectively referred to generally in this document as a Satellite Positioning System (SPS)). As used in this document, an SPS also includes pseudolite (pseudo-satellite) systems.

The term “instrument” in combination with the words “mobile wireless communications,” means and includes at least a cellular phone and a pager, a satellite telephone, a two-way pager, a personal digital assistant (“PDA”) having wireless capabilities, a portable computer having wireless capabilities, home entertainment system control boxes, wireless local area networks, and any other type of wireless device having transmission capabilities that may also be one or more versions of a personal communications services device (“PCS”) including time division multiple access (“TCMA”), a code division multiple access (“CDMA”), a global system for mobile (“GSM”), non-voice communications apparatus, and text transmission apparatus, among others.

The term “point-of-sale device” means at least a terminal or other device consisting of peer-to-peer near field communications devices, and ISO 14443-compliant contactless card, and ISO 18092-compliant FeliCa card among others. Thus, a point-of-sale device includes not only credit card and debit card readers (that may include touch screens), but also automatic and automated teller machines (“ATM's”), among others.

The term “credit network” means a national and/or worldwide system in which financial institutions, merchants, and public users are connectable. Credit networks were designed for use primarily with payment instruments. Payment instruments allow public users, or customers, to use, for example, a credit or debit card to purchase goods or services in substantially real time following authentication of the customer, and approval of the transaction by a financial institution. A user, or customer (in this document, “user” or “customer”), is issued a payment instrument such as a credit or debit card after an account has been approved by the credit provider, often a financial institution such as a bank, with which the user is able to make purchases from merchants who accept the credit, up to a pre-established limit. In addition, a “card association” often is included in the credit network, and includes among others VISA® and MasterCard® which act as gateways between a financial institution and issuer for authorizing and funding transactions, the issuer being a financial institution or other organisation that issued the credit/debit card to the cardholder.

The flow of information and money among the various parties across a credit network, almost always through card associations, is known as the “interchange.” The interchange includes a number of steps. The first step is authorization, in which the cardholder pays for a purchase, and the merchant submits the transaction to a financial institution that verifies, almost instantly, that the card number and transaction amount both are valid, and then processes the transaction for the cardholder. Another step includes “batching,” which is the step by which a transaction is authorized and then stored in a batch that the merchant sends to the financial institution for later payment. Another step includes clearing and settlement, which is when the financial institution sends the transactions in a batch through the card association that debits the issuers for payment and credits the financial institution. Finally, there is the step of funding. Once the financial institution has been paid, the merchant receives payment.

The terms “financial data” and “financial information” mean at least any and all economics data related to matters of money and the markets. Financial data may be personal and/or commercial. Financial data and information is concerned with management of money, banking, credit, investments and assets.

The term “financial transaction” means at least the use of financial data and financial information used in exchange or transfer of goods, services or funds, generally based on contract, agreement, bargain and similar transactions using a payment instrument.

The term “payment instrument” means at least a credit card, a debit card, a contactless card, debit lines, debit coupons, and cash equivalents.

The term “one or more databases for storing, receiving and transmitting financial data” means at least a mobile wireless communications instrument operatively connected to a computer.

The term “user” means a person or persons authorized to use the mobile wireless communications instrument and to access either a credit network to conduct and conclude payments in connection with one or more payment instruments, or one or more databases for storing, receiving and transmitting financial data.

The word “exemplary” is used herein to mean “serving as an example, instance, or illustration.” Any aspect described in this document as “exemplary” is not necessarily to be construed as preferred or advantageous over other aspects.

### Description

The apparatus, system, and method disclosed in this document addresses the above stated needs by providing a mobile wireless communications instrument. A data processor or data processing system, is operatively connected to the mobile wireless communications instrument. In one aspect, the data processing system includes a plurality of user programmable sets of instruction executable by the data processing system for selectively conducting financial transactions using the mobile wireless communications instrument. In another aspect, the data processing system is capable of securely receiving, storing, transmitting, and conducting a wide variety of financial transactions across a credit network. In another aspect, the data processing system is capable of receiving, storing, and transmitting programmable payment instructions in connection with not only one payment instrument, but in connection with a plurality of payment instruments.

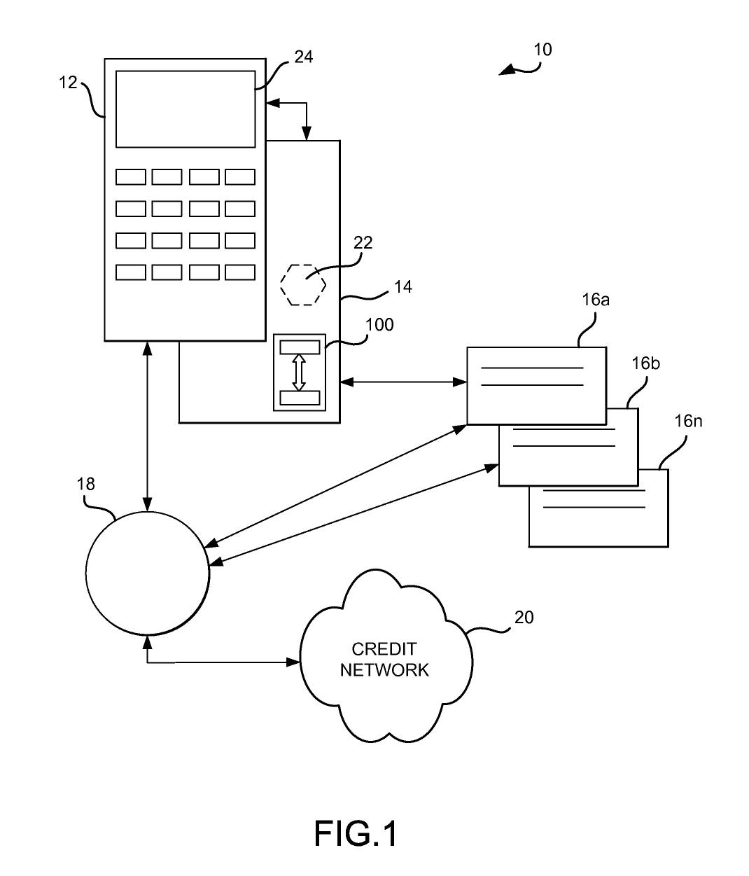

More specifically, in at least one aspect of the apparatus, system, and method disclosed, illustrated and claimed in this document, a point-of-sale payment system 10 is provided that includes a portable, or mobile, wireless communications instrument 12, as illustrated in FIG. 1 schematically and diagrammatically. The mobile wireless communications instrument 12 is selected from the group of mobile wireless communications instruments consisting of cellular phones, communication apparatus providing personal communications services (PCS) including time division multiple access (TDMA), code division multiple access (CDMA) and global system for mobile (GSM), non-voice communication apparatus, text transmission apparatus, satellite telephones, two-way pagers, personal digital assistants, portable wireless computers, a wireless instrument specifically designed to implement financial data transactions, among others.

As also illustrated in FIG. 1, the point-of-sale payment system includes a computer 14. As shown, fee computer 14 is operatively connected to the portable, or mobile, wireless communications instrument 12. In one aspect, the computer 14 also is housed in the portable wireless communications instrument 12. The computer 14 is adapted to transmit and receive programmable payment instructions in connection with one more payment instruments 16a-n. In operation, any and all data electronically or otherwise embedded in and on the one or more payment instruments 16a-n, as shown in FIG. 1, as well as any other data associated with a customer, a financial institution, and/or a card association, is stored in the computer 14 of the mobile wireless communications instrument 12 for use as further described in this document.

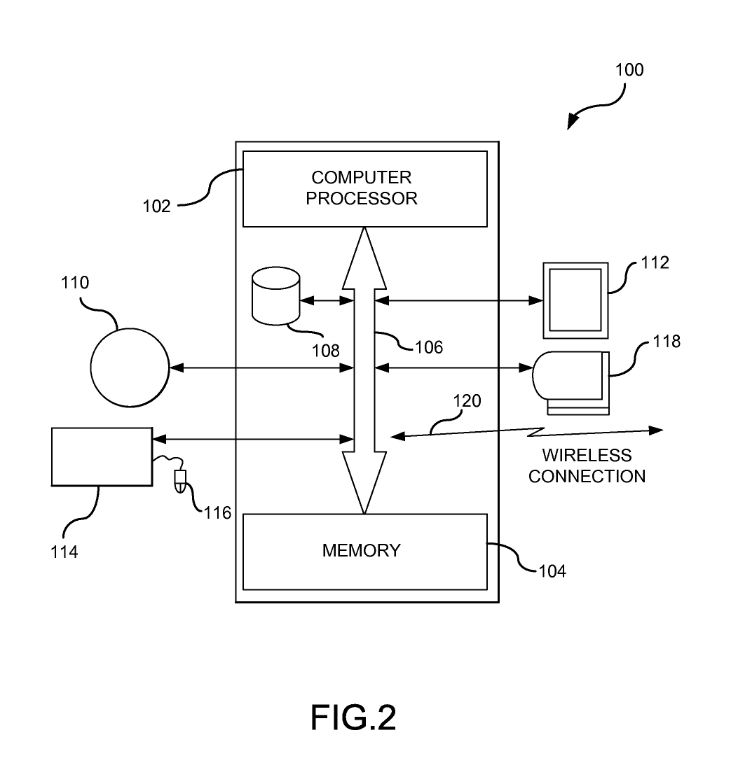

The computer of the mobile communications instrument 12 includes a data processing system 100 as illustrated in a non-exclusive example in the block diagram in FIG. 2. As shown, the data processing system 100 may include a variety of components to enable the mobile communications instrument 12 to send and receive data and information to a point-of-sale device 18, including a computer processor 102, memory 104, the computer processor and memory connected by a bus 106. Memory 104 is a relatively high-speed machine-readable medium and includes volatile memories such as DRAM, and SRAM, as well as non-volatile memories such as ROM, FLASH, EPROM, EEPROM, and bubble memory. Also connectable to the bus 106 are optional secondary storage 108, external storage 110, output devices such as a monitor 112 that may be mounted on the mobile wireless communications system 12, in optional configurations an input device such as a keyboard 114 with a mouse 116, and perhaps even a printer 118. Secondary storage 108 may include machine-readable media such as a hard disk drive, a magnetic drum, and a bubble memory. External storage 110 may include machine-readable media such as a floppy disk, a removable bard drive, a magnetic tape, CS-ROM, and even other computers, possibly connected via a communications line 120. The distinction between secondary storage 108 and external storage 110 is primarily for convenience in describing the invention. As such, a person skilled in the art will appreciate that there is substantial functional overlap between and among the components. Computer software and user programs can be stored in a software storage medium such as memory 104, secondary storage 108, and external storage 110. Executable versions of computer software can be read from a storage medium such as non-volatile memory, loaded for execution directly into volatile memory, executed directly out of non-volatile memory, or stored on the secondary storage 108 prior to loading into volatile memory for execution.

In addition, those skilled in the art also will appreciate that the various illustrative logical blocks, modules, circuits, and algorithm steps described in connection with the aspect of the invention disclosed in this document may be implemented as electronic hardware, computer software, or combination of both. To clearly illustrate this interchangeability of hardware and software, various illustrative and non-exclusive components, blocks, modules, circuits, and steps have been described in this document generally in terms of their functionality. Whether such functionality is implemented as hardware or software depends on the particular application and design constraints imposed on an overall system. Skilled artisans may implement the described functionality in varying ways for each particular application, but such implementation decisions should not be interpreted as causing a departure from the scope of the present invention.

The various illustrative logical blocks, modules, and circuits described in connection with the aspects disclosed in this document may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices such as, in a non-exclusive example, a combination of a DSP and a microprocessor, a plurality of microprocessors, one or more microprocessors in conjunction with a DSP core, or any other such configuration.

The computer 14 of the wireless communications instrument 12 is capable of communicating with the point-of-sale device 18 in part due to use of a near-field communications system, or similar technology. In operation, the user brings the wireless communications instrument 12 adjacent the point-of-sale device 18 and, using keys or other means for transmitting signals and information, transmits instructions in connection with, payment instruments 16a-n to the point-of-sale device 18 using one or more near-field communications systems.

So-called “near-field communication” (NFC) systems have become known, and standards for NFC systems have been, ratified. In accordance with the standards, NFC systems are limited to a range of only about 10 cm and are capable of a bit transfer rate of 424 kilobits per second using a carrier frequency of 13.56 MHz. Similarly to radio frequency identification (RFID) systems, on which the new NFC standards are based, a principal function contemplated for NFC devices is the capacity to interrogate them in a passive mode in which they consume no power and to have a unique code, previously stored, rapidly and reliably returned in a manner which does not interfere with other wireless communications, and which minimizes or avoids interference from such other wireless communications whenever such an interrogation is made. Accordingly, NFC systems transmit information by inductive electromagnetic coupling in the radio frequency portion of the spectrum. The NFC standard also provides for software that enables nearly instantaneous peer-to-peer network setup. NFC devices thus effectively seek each other and establish a communication link between themselves in sharp contrast to, for example, so-called Bluetooth enabled devices in which, while also intended for short range peer-to-peer communications, setup procedures are complex and extended, largely to establish device configuration which is unnecessary in NFC systems. This networking facility is in sharp contrast to RFID systems which are set up in a master/slave relationship in which usually passive chips or transponders are read by relatively expensive, powered reader devices having a range of about two to five meters. NFC systems also differ from other types of known wireless communication systems such as so-called Wi-Fi systems that generally require an access hub. Further, NFC devices can be set to either an active or passive mode such that identification data can be sent even when the device is off and consuming no power. Even in an active mode, the range of NFC devices is so small that very little power is consumed. Accordingly, NFC devices have been implemented in single chips and chip sets for a wide variety of applications, and are appropriate for use in connection with the point-of-sale payment system 10 described in this document.

As also illustrated in FIG. 1, the point-of-sale payment system includes a point-of-sale device 18. The point-of-sale device 18 is operatively connectable, on demand, to the portable wireless communications instrument 12. The point-of-sale device 18 is adapted to receive and process payment data. More specifically, the point-of-sale device 18 is adapted to receive and process payment data across a credit network 20 to which the point-of-sale device 18 is operatively connectable. The point-of-sale device 18 may be a peer-to-peer near field communications device, an ISO 14443-compliant contactless card, and an ISO 18092-compliant FeliCa card, among others.

The point-of-sale payment system 10 illustrated in FIG. 1 also includes at least one algorithm 22 shown diagrammatically in FIG. 1. The algorithm 22 may be included in the computer 14. In one aspect, the at least on algorithm 22 is formulated to be responsive to a user's programmable preferences for payment from the one or more payment instruments 16a-n. The programmable preferences for payment may be presented to and viewed by the user on the mobile wireless communications instrument 12 as a range of selectable options and/or settings. As one non-exclusive example, as shown in FIG. 1, a monitor 24 may be mounted on the mobile wireless communications instrument, and the user may scroll through the range of selectable options and/or settings, selecting one or more options. Because payment algorithm 22 is programmable by the user, or may be selected from a range of selectable options and/or settings by the user, die point-of-sale payment system 10 allows a user to decide on personal strategies for making payments from one or more payment instruments 16a-n. The one more payment instruments 16a-n may include any combination or permutation of use of more than one payment instrument 16a-n that may include credit cards, debit cards, contactless cards, cash equivalents stored in the computer or on-line, and coupons, among others.

The point-of-sale payment 10 system illustrated in FIG. 1 also is capable of loading, displaying, and transmitting user financial information and data to prepare a range of financial data reports selected by the user of the mobile wireless communications instrument 12. For example, the user may store in the computer 14 a variety of personal or business financial reports such as, for example, a balance sheet, income statement, and similar reports. Such reports may be transmitted either across the credit network 20, to other databases and terminals in the discretion of the user.

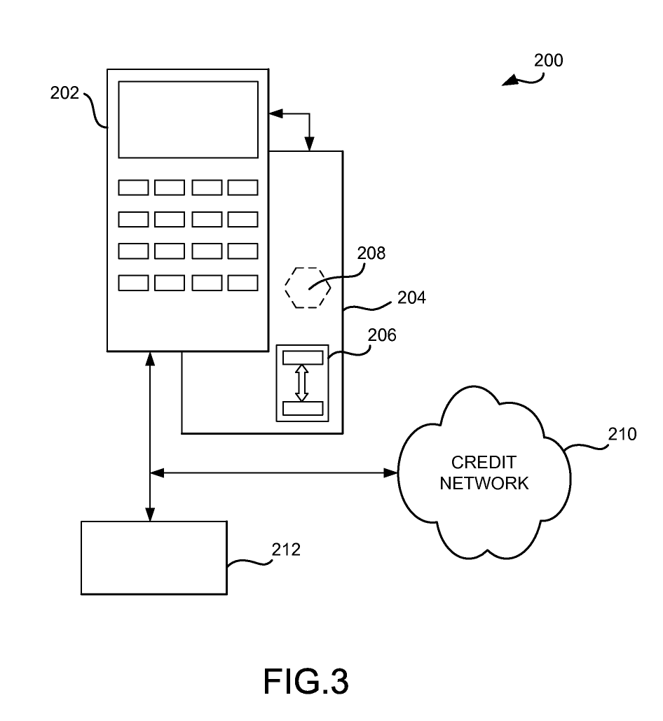

In another aspect of the apparatus, system, and method disclosed, illustrated and claimed in this document, as shown in FIG. 3, a financial data apparatus 200 is provided. As shown, the financial data apparatus 200 includes a mobile wireless communications instrument 202. The mobile wireless communications instrument 202 may be any of the optional mobile wireless communications instruments already described in this document.

As illustrated by cross-reference between FIGS. 2 and 3, in a computer 204 operatively connected to the mobile wireless, communications system 202 is a data processing system 206. The data processing system 206 may include one or more of the functionalities and components of the data processing system 100 illustrated in FIG. 2. A wide array of financial data may be stored in a memory 104, 108, and/or 110 as illustrated by cross-reference between FIGS. 2 and 3.

To enable the financial data apparatus 200 to selectively conduct financial transactions using the mobile wireless communications instrument 202, a plurality of user programmable sets of instructions 208 executable by the data processing system 206 for selectively conducting financial transactions is provided. The plurality of user programmable sets of instructions 208 may be linked to any number of databases 212.

In addition, the financial data apparatus 200 includes means, both hardware and software, operatively connectable to the mobile wireless communications instrument 202 for securely receiving, transmitting, and concluding the financial transactions not only across a credit network 210, but also across any network of interconnected and interconnectable computers and databases 212.

Those of skill in the art also will appreciate that the method steps claimed in this document can be interchanged and are interchangeable without departing from the scope of the invention.

Those of skill in the art also would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosed aspects is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the aspects shown is this document, but is to be accorded the widest scope consistent with the principles and novel features disclosed herein.

1. A point-of-sale payment system, comprising:
a portable wireless communications instrument;
a computer housed in the portable wireless communications instrument adapted to receive, store, and transmit programmable payment instructions in connection with one more payment instruments; and
a point-of-sale device operatively connectable to the portable wireless communications instrument device adapted to receive and process payment data,
wherein the point-of-sale device also is operatively connected to a credit network.

2. A point-of-sale payment system as recited in claim 1, wherein the portable wireless communications instrument is a cellular telephone.

3. A point-of-sale payment system as recited in claim 2, wherein the point-of-sale device is selected from fee group of point-of-sale devices consisting of peer-to-peer near field communications devices, an ISO 14443-compliant contactless card, and an ISO 18092-compliant FeliCa card, among others.

4. A point-of-sale payment system as recited in claim 3, wherein the computer further comprises a plurality of payment algorithms responsive to a portable wireless communications instrument user's programmable preferences for payment from the one or more payment instruments.

5. A point-of-sale payment system as recited in claim 4, wherein the plurality of payment algorithms are presented on the portable wireless communications instrument as a range of selectable options and/or settings.

6. A point-of-sale payment system as recited in claim 5, wherein the plurality of payment algorithms is programmable by the user of the portable wireless communications instrument to implement one or more payment strategies selected by the user.

7. A point-of-sale payment system as recited in claim 6, wherein the one more payment instruments is selected from the group of payment instruments consisting of credit cards, debit cards, cash equivalents stored in the computer or on-line, and coupons, among others.

8. A point-of-sale payment system as recited in claim 7, further comprising programmable user reports selectively obtainable by the user of the portable wireless communications instrument.

9. A computer related financial data apparatus, comprising:
a mobile wireless communications instrument;
a data processing system operatively connected to the mobile wireless communications instrument adapted to process financial data;
a plurality of user programmable sets of instruction executable by the data processing system for selectively conducting financial transactions using the mobile wireless communications instrument; and
means operatively connectable to the mobile wireless communications instrument for securely receiving, transmitting, and concluding the financial transactions across a credit network.

10. A computer related financial data apparatus as recited in claim 9, wherein the mobile wireless communications instrument is selected from the group of mobile wireless communications instruments consisting of cellular telephones, communication apparatus providing personal communications services (PCS) including time division multiple access (TDMA), code division multiple access (CDMA) and global system for mobile (GSM), non-voice communication apparatus, text transmission apparatus, satellite telephones, two-way pagers, personal digital assistants, portable wireless computers, and wireless instruments specifically designed to implement financial data transactions, among others.

11. A computer related financial data apparatus as recited in claim 9, wherein the data processing system includes a computer processor.

12. A computer related financial data apparatus as recited in claim 9, wherein the data processing system includes a memory unit connected to the computer processor by a bus adapted to store at least the plurality of user programmable sets of instruction executable by the data processing system.

13. A computer related financial data apparatus as recited in claim 9, wherein the means operatively connectable to the mobile wireless communications instrument for concluding the financial transactions across a credit network includes a point-of-sale device.

14. A computer related financial data apparatus as recited in claim 13, wherein the means operatively connectable to the mobile wireless communications instrument for concluding the financial transactions across a credit network includes a terminal operatively connected to the point-of-sale device.

15. A computer related financial data apparatus as recited in claim 9, wherein the means operatively connectable to the mobile wireless communications instrument for concluding the financial transactions across a credit network includes a means for authenticating the user across the credit network.

16. A computer related financial data apparatus as recited in claim 9, wherein the means operatively connectable to the mobile wireless communications instrument for concluding the financial transactions across a credit network includes means for maintaining security of the financial transactions.

17. A method of providing financial information through a mobile wireless communications instrument, comprising the steps of:
selecting a mobile wireless communications instrument;
including in the mobile wireless communications instrument a data processing system operatively connected to the mobile wireless communications instrument adapted to process financial data; and
including a device operatively connectable to the mobile wireless communications instrument for receiving and transmitting the financial data to one or more databases.

18. A method of providing financial information through a mobile wireless communications instrument as recited in claim 17, further comprising the step of operatively connecting the mobile wireless communications instrument and the device for receiving and transmitting instructions in connection with the financial data to a credit network for concluding payment from one or more payment instruments.

19. A method of providing financial information through a mobile wireless communications instrument as recited in claim 17, wherein the step of selecting a mobile wireless communications instrument includes the substeps of selecting one or more:
cellular telephones;
personal communications services devices;
non-voice communication apparatus;
text transmission apparatus; and/or
other means for storing and transmitting financial data.

20. A method of providing financial information through a mobile wireless communications instrument as recited in claim 17, wherein the step of including in the mobile wireless communications instrument a data processing system includes the substep of including a plurality of algorithms responsive to a programmable preferences either for concluding payments, or for collecting and reporting financial data.

21. A method of providing financial information through a mobile wireless communications instrument as recited in claim 17, wherein the step of including a device operatively connectable to the mobile wireless communications apparatus includes the substep of including a near field communications unit.

22. A method of providing financial information through a mobile wireless communications instrument as recited in claim 17, wherein the step of connecting operatively the mobile wireless communications apparatus and the device to a for receiving and transmitting the financial data to one or more databases includes the substeps of effecting a payment from a plurality of payment instruments selected from:
credit cards;
debit cards;
cash equivalents stored in the computer;
coupons; and/or
other payment instruments.
